(19) United States
(12) Patent Application Publication
(10) Pub. No.: US 2010/0306821 A1
(43) Pub. Date: Dec. 2, 2010

(54) ACCOUNT-RECOVERY TECHNIQUE

(75) Inventors: Robert William Cathcart, San Francisco, CA (US); Stephen P. Middlekauff, San Francisco, CA (US); Laura M. Wallace, Palo Alto, CA (US); Colin M. Bogart, San Francisco, CA (US); Jose L. Fernandez Martinez, Mountain View, CA (US); Diana D. Wilson, San Francisco, CA (US); Matthew J. Schweitz, San Francisco, CA (US); Albert Bachand, San Francisco, CA (US); Jessica S. Bronesky, San Francisco, CA (US)

Correspondence Address: Google Inc.;c/o Park, Vaughan & Fleming LLP, 2820 Fifth Street, Davis, CA, 95618, US

(73) Assignee: Google, Inc., Mountain View, CA (US)

(21) Appl. No.: 12/474,782

(22) Filed: May 29, 2009

(51) Int. Cl. G06F 7/04; G06Q 10/00; G06Q 50/00; G06F 7/06; G06F 17/30

(52) U.S. Cl. 726/3; 705/7; 707/E17.044

(57) ABSTRACT

Embodiments of a computer system, a method, and a computer-program product (e.g., software) for use with the computer system are described. These embodiments may be used to evaluate a user request to regain control of an online account. For example, the user request may be submitted online using a web page, and may include information that establishes the user's identity or that substantiates that the user is the owner of the online account, such as a history of recent activities associated with the online account. This information may be evaluated by comparing it to stored information associated with the online account, such as a stored history of recent activities or one or more locations of a registered user when the registered user previously accessed the online account. After evaluating the user request, remedial action may be performed.

### BACKGROUND

1. Field

The present embodiments relate to techniques for restoring user control over an online account.

2. Related Art

Online services presently enable millions of users to perform various actions, such as communicating via e-mail and exchanging information on blogs or social networks. In order to use an online service, a user typically establishes an account, which is subsequently accessed by providing login information, such as an account identifier and a password.

Unfortunately, users of online services frequently lose the ability to access their accounts. For example, they may forget their login information or their accounts may be stolen by unauthorized users, who gained access to a user's account and then changed the user's password (which is sometimes referred to as ‘hijacking’).

To address this problem, many online service providers offer self-recovery systems that users can use to recover their accounts. For example, when a user first sets up an account, the user may provide recovery information, including: a secondary password (such as a secret question and an associated answer), an alternate contact address associated with the account (such as an e-mail address to which recovery information can be sent), and/or additional information about the user (such as biographical information or a Social Security number).

However, these self-recovery systems do not always work. For example, in addition to forgetting login information, users often forget the recovery information associated with their accounts. Moreover, if their accounts are hijacked, the unauthorized users may be able to modify the recovery information before the users are able to recover their accounts.

If a user has problems with a self-recovery system, the only recourse for the user is to contact the appropriate service provider. During this process, the user typically provides additional information about the account that only the user would know, and a customer-service representative evaluates this additional information on a case-by-case basis. However, this is a time-consuming process, which is frustrating for users and increases operating expenses for the service provider.

### SUMMARY

One embodiment provides a system that responds to a request for corrective action. During operation, the system receives the request for corrective action from a potential user of an online account. This request may include account information, registered-user information and history information for activities associated with the online account. Then, the system accesses stored information for the online account, which includes stored history information for activities associated with the online account. Next, the system generates an ownership score based at least in part on the information in the request and the stored information for the online account. After determining if the potential user is an owner of the online account based at least in part on the ownership score, the system performs remedial action in response to the request.

During normal operation, the online account may be accessed by providing login information. Moreover, the online account may be associated with: an e-mail account, a blog, a website, a search history, health records, an advertising account, and/or a merchandise account.

However, if the potential user has lost control over the online account, the potential user may submit the request. For example, the loss of control may include forgetting login information associated with the online account or an unauthorized party taking control of the online account. Moreover, the request may be included in a document that is submitted online, such as a web page.

The potential user may provide a variety of information to establish their identity or to substantiate their ownership of the online account. For example, the registered-user information may include information associated with other services provided to the potential user by a host of the online account. Moreover, the account information may include currently inactive login information that was previously used to access the online account. Additionally, the history information for activities associated with the online account may include account activities within a time interval, such as individuals e-mailed by the potential user during the time interval.

In order to determine if the potential user is the owner of the online account, the system may access a variety of information. For example, the stored history information for activities associated with the online account which is accessed by the system may include one or more locations of a registered user when the registered user previously accessed the online account.

Moreover, the system may perform one or more additional operations when determining if the user is the owner. For example, the system may compare a location of the potential user at the time the request was submitted with the one or more locations and/or a location from which a most-recent change to the account was received with the one or more locations. Additionally, the system may compare a weighted summation of determining factors to a threshold value.

Note that the remedial action may include: returning control of the online account to the owner; disabling the online account; providing login information to the owner; and/or taking no action in response to the request. Moreover, the system may communicate to the potential user the remedial action performed in response to the request.

Another embodiment provides a method including at least some of the above-described operations that are performed by the system.

Another embodiment provides a computer-program product for use in conjunction with a computer system. This computer-program product may include instructions corresponding to at least some of the above-described operations that are performed by the computer system.

Another embodiment provides the computer system.

### BRIEF DESCRIPTION OF THE FIGURES

FIG. 1 is a flowchart illustrating an embodiment of a process for responding to a request for corrective action.

FIG. 2 is a block diagram illustrating a networked computer system that receives the request for corrective action and performs associated remedial action.

FIG. 3A is a block diagram illustrating an embodiment of a form on a webpage that a potential user of an online account can use to submit the request for corrective action.

FIG. 3B is a block diagram illustrating an embodiment of a form on a webpage that a potential user of an e-mail account can use to submit the request for corrective action.

FIG. 4 is a block diagram illustrating an embodiment of a computer system that evaluates requests for corrective action and performs the associated remedial action.

FIG. 5 is a block diagram illustrating an embodiment of a data structure.

Note that like reference numerals refer to corresponding parts throughout the drawings.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present disclosure is not intended to be limited to the embodiments shown, but is to be accorded the widest scope consistent with the principles and features disclosed herein.

Embodiments of a computer system, a method, and a computer-program product (e.g., software) for use with the computer system are described. These embodiments may be used to evaluate a user request to regain control of an online account. For example, the user request may be submitted online using a web page, and may include information that establishes the user's identity or that substantiates that the user is the owner of the online account, such as a history of recent activities associated with the online account. This information may be evaluated by comparing it to stored information associated with the online account, such as a stored history of recent activities or one or more locations of a registered user when the registered user previously accessed the online account. After evaluating the user request, remedial action may be performed. This remedial action may include: returning control of the online account to the owner; disabling the online account; providing login information to the owner; and/or taking no action in response to the user request.

By evaluating the user request and taking appropriate remedial action, this technique allows users to recover control of an online account without having to recall recovery information, such as a secondary password, a secret question/answer, and/or alternate contact information. Moreover, a service provider of the online account may be able to handle user requests more efficiently, thereby reducing time delays, user frustration and operating expenses.

We now describe embodiments of a process for responding to a request for corrective action. During normal operation of an online account, a user may access the online account, for example, by providing login information (such as a username and a password). This online account may be associated with a variety of services or types of information provided by a host or a service provider (henceforth referred to as an ‘online service’ and a ‘service provider,’ respectively). For example, the online account may be associated with: an e-mail account of the user, a user blog, a user website, a search engine (such as a search history for the user), health records of the user, an advertising account of the user, and/or a merchandise account of the user (which the user may use to sell or purchase items).

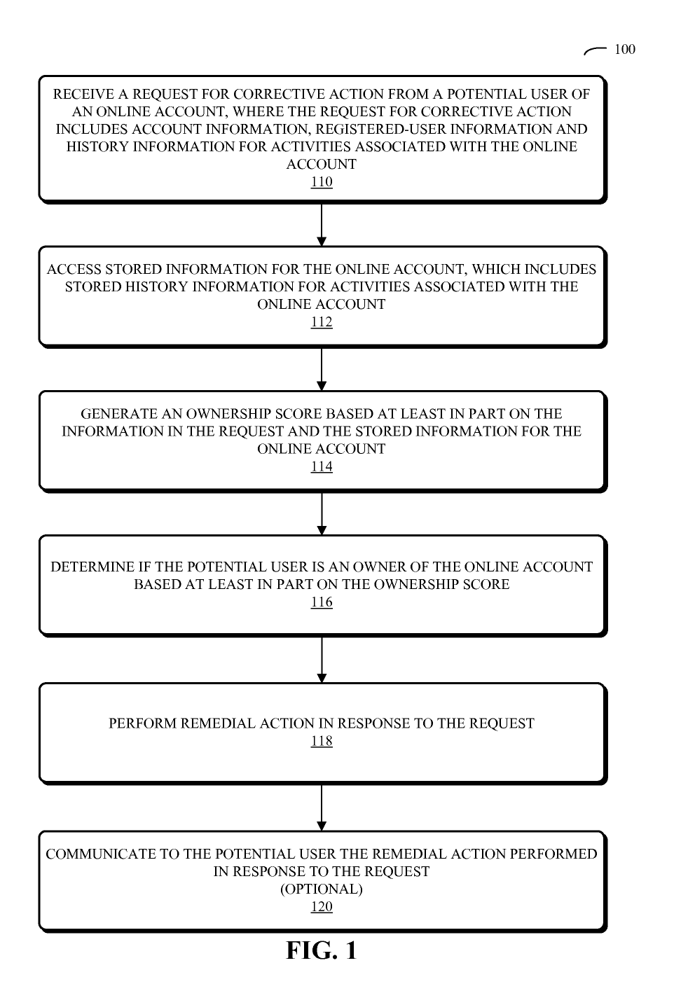

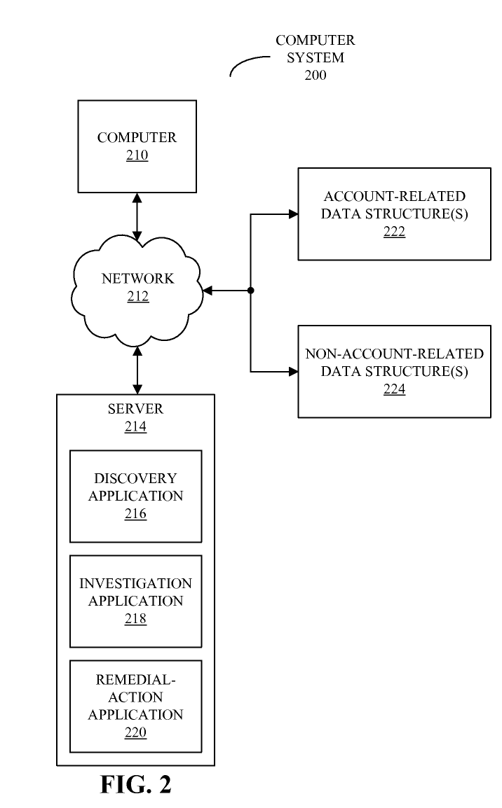

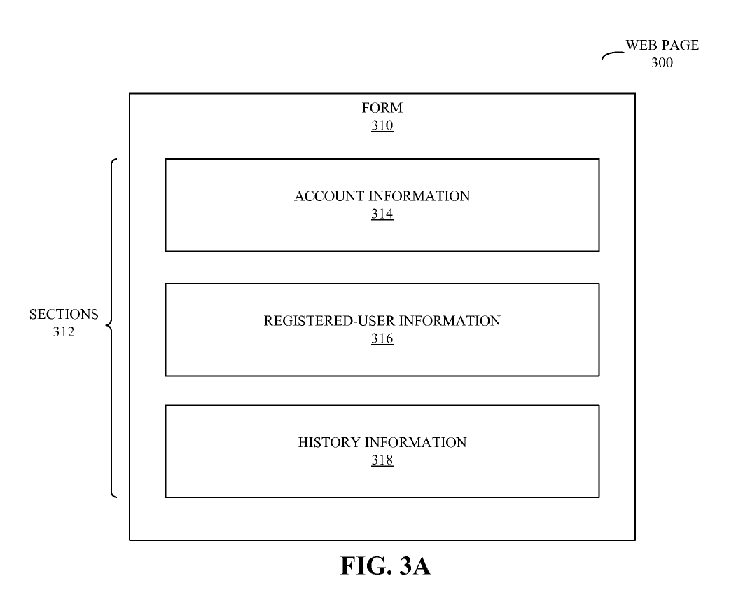

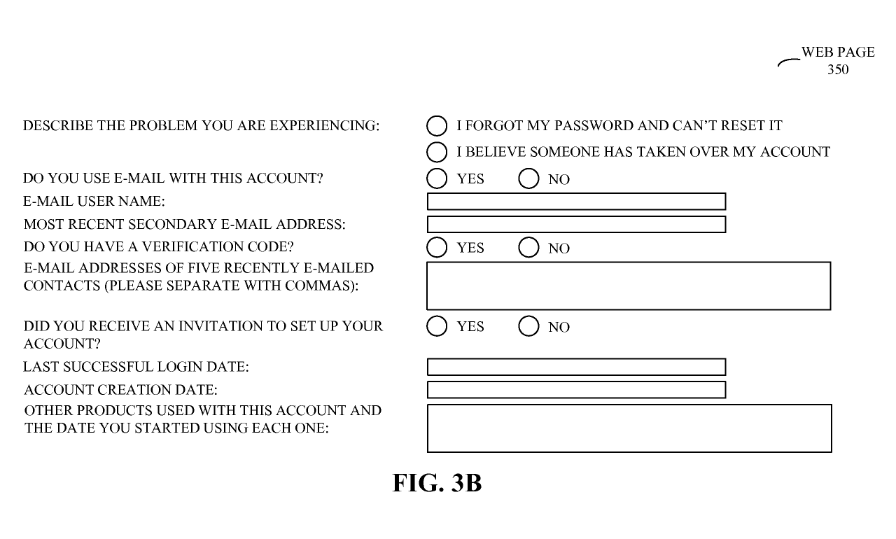

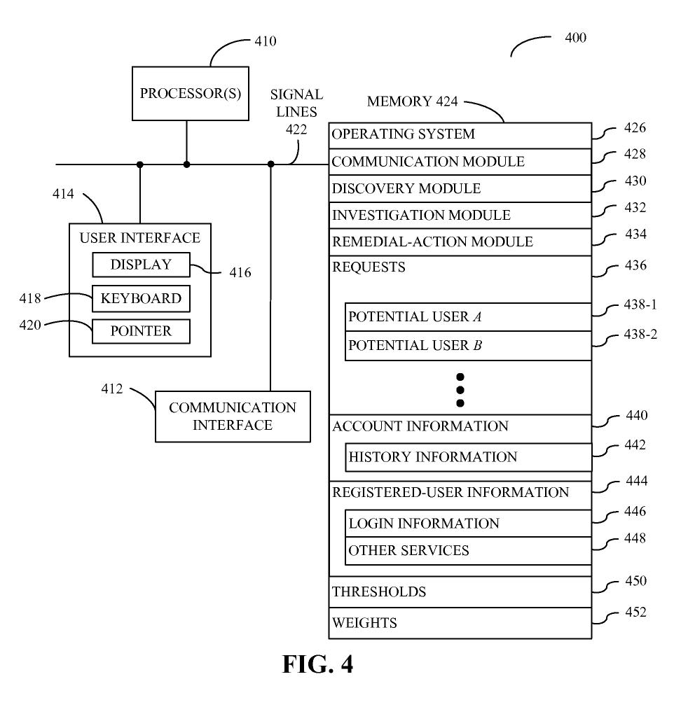

However, if the user loses control over the online account (such as when the user forgets the login information or an unauthorized party takes control of the online account), the user may submit a request for corrective action to the service provider of the online account (who views the user as a ‘potential user’ until the request is evaluated). As described further below with reference to FIG. 3, this request may be submitted online, for example, by completing a form on a web page. Moreover, as described further below with reference to FIGS. 2 and 4, this request may be processed by a computer system using a process 100 for responding to a request for corrective action, which is shown in FIG. 1.

During operation, the computer system receives the request for corrective action from a potential user of an online account (110). This request may include account information, registered-user information and history information for activities associated with the online account. Then, the computer system accesses stored information for the online account (112), which includes stored history information for activities associated with the online account. Next, the computer system generates an ownership score based at least in part on the information in the request and the stored information for the online account (114). After determining if the potential user is an owner of the online account based at least in part on the ownership score (116), the computer system performs remedial action in response to the request (118).

In some embodiments, the computer system optionally communicates to the potential user the remedial action performed in response to the request (120). Note that process 100 may include additional or fewer operations. Moreover, the order of the operations may be changed, and/or two or more operations may be combined into a single operation.

We now describe embodiments of the computer system that may be used to receive and respond to a request for corrective action. FIG. 2 presents a block diagram illustrating a networked computer system 200 that receives the request for corrective action and performs associated remedial action. In this computer system, the user may access the online account from computer 210 via network 212. For example, server 214 may provide instructions for a web page corresponding to the online account via network 212, which is rendered by a web browser on computer 210. This network may include: the Internet or World Wide Web (WWW), an intranet, a local area network (LAN) (such as IEEE 802.11 or WiFi), a wide area network (WAN) (such as IEEE 802.16 or WiMAX), a metropolitan area network (MAN), a satellite network, a wireless network (such as a cellular telephone network), an optical network, and/or a combination of networks or other technology enabling communication between computing systems or electronic devices. Consequently, the ‘online’ account should be understood to include an account that is implemented on a network with limited or restricted access (such as an intranet) or a network that can be accessed by a general user (such as the Internet).

Additionally, the online service associated with the online account may be implemented using a software-application tool that is embedded in the web page. This software-application tool may be a software package written in: JavaScript™ (a trademark of Sun Microsystems, Inc.), e.g., the software-application tool includes programs or procedures containing JavaScript instructions, ECMAScript (the specification for which is published by the European Computer Manufacturers Association International), VBScript™ (a trademark of Microsoft, Inc.) or any other client-side scripting language. In other words, the embedded software-application tool may include programs or procedures containing: JavaScript, ECMAScript instructions, VBScript instructions, or instructions in another programming language suitable for rendering by the web browser or another client application on the computer 210. Therefore, in some embodiments the user of the software-application tool may not have to download an application program onto computer 210 in order to use it.

As noted previously, if the user loses control of the online account, the user may send a request for corrective action to the service provider, for example, by completing one or more forms on a web page (which may be the same web page as that associated with the online account or a different web page) using the web browser on computer 210, which is then submitted to server 214 via network 212.

FIG. 3A presents a block diagram illustrating an embodiment of a form 310 on a webpage 300 that a potential user of an online account can use to submit the request for corrective action. By completing different sections 312 of form 310 in web page 300, the user can provide a variety of information to establish their identity or to substantiate their ownership of the online account (e.g., that they are the current registered user of the online account, or the previous registered user if the online account has been hijacked and the hijacker has subsequently changed the registration information associated with the online account).

The information provided by the user may include information that only the true owner of the online account should know. For example, the provided information may include account information 314, such as currently inactive login information (e.g., an old password) that was previously used to access the online account. Moreover, the provided information may include registered-user information 316, such as information associated with one or more other services provided to the user by the service provider (e.g., if the online account is an e-mail account, the user may provide a uniform resource locator or URL for a website, such as a user blog, that is also hosted by the service provider). Additionally, the provided information may include history information 318 for activities associated with the online account, such as account activities within a time interval (e.g., if the online account is an e-mail account, the history information 318 may include individuals recently e-mailed by the user and/or the most frequently e-mailed contacts of the user). In general, the information provided by the user may be classified as unique identifiers (such as an e-mail address of the user which is directly associated with the online account) and non-unique identifiers for the user (such as an e-mail address of the user which is associated with multiple online accounts).

FIG. 3B presents a block diagram illustrating an exemplary embodiment of a form on a webpage 350 that a potential user of an e-mail account can use to submit the request for corrective action. The user may select different items by clicking on a circle using a mouse and/or may provide information by typing text in one or more of the boxes.

Continuing the discussion of FIG. 2, after server 214 receives and stores the request (including the provided information), a discovery application 216 that is resident on and which executes on server 214 may access a variety of information that is stored locally or remotely in computer system 200, such as information stored in one or more account-related data structures 222 and/or one or more non-account-related data structures 224. For example, the discovery application 216 may access account-related data structures 222 to determine/confirm which online account corresponds to the request. Moreover, the discovery application may access stored history information for activities associated with the online account in account-related data structures 222. This stored history information may include one or more locations of the (then) registered user when the registered user previously accessed the online account.

Then, an investigation application 218 that is resident on and which executes on server 214 may determine if the user (who, from the perspective of server 214, is still a potential user of the online account) is the owner of the online account. For example, the investigation application 218 may compare the information provided by the user with the stored information, and may add points for each piece of correct information provided and/or may subtract points for each piece of incorrect information provided.

In an exemplary embodiment, during the determining, the investigation application 218 compares a weighted summation of determining factors (which is sometimes referred to as an ownership score) to a threshold value, and if the weighted sum exceeds the threshold, the potential user is deemed to be the owner of the online account. Note that the various factors included in the determination (e.g., for an e-mail account, frequent e-mail contacts, e-mails sent or received during the last week or month, and/or old or inactive login information) may have different weights (i.e., some factors may be more important than others).

One or more of these factors may include locations, such as an Internet-protocol (IP) address from which the request was submitted (for example, an IP address associated with computer 210) and one or more IP address(es) from which the online account has been previously accessed. Changes in these locations may be indicative of suspicious behavior such as account hijacking. Other indications of suspicious behavior may include: receiving changes to login information for the online account from a location (such as an IP address) that is different from the location(s) from which the online account has previously been accessed; and/or receiving changes to the login information from a location that matches one of the locations from which the online account has been previously accessed, but having subsequent accesses of the online account occurring from one or more different locations than the location(s) from which the online account has been previously accessed.

After a decision has been made regarding the request (i.e., after the determining operation 116 in FIG. 1), remedial-action application 220 resident and executing on server 214 may return control of the online account to the user. For example, remedial-action application 220 may provide login information to the user, which may be the current (stored) login information associated with the registered user for the online account or new login information. However, if it is unclear as to whether or not the user is indeed the owner of the online account and/or if activities associated with the online account are suspicious, remedial-action application 220 may disable the online account. Alternatively, remedial-action application 220 may take no action in response to the request. In general, remedial-action application 220 may communicate to the user the remedial action taken in response to the request, for example, by sending a standard e-mail template to an e-mail address provided by the user when completing form 310 in web page 300 (FIG. 3A).

We now describe the computer system in more detail. FIG. 4 presents a block diagram illustrating an embodiment of a computer system 400 that evaluates requests for corrective action and performs the associated remedial action. Computer system 400 includes: one or more processors 410, a communication interface 412, a user interface 414, and one or more signal lines 422 coupling these components together. Note that the one or more processing units 410 may support parallel processing and/or multi-threaded operation, the communication interface 412 may have a persistent communication connection, and the one or more signal lines 422 may constitute a communication bus. Moreover, the user interface 414 may include: a display 416, a keyboard 418, and/or a pointer 420, such as a mouse.

Memory 424 in the computer system 400 may include volatile memory and/or non-volatile memory. More specifically, memory 424 may include: ROM, RAM, EPROM, EEPROM, flash, one or more smart cards, one or more magnetic disc storage devices, and/or one or more optical storage devices. Memory 424 may store an operating system 426 that includes procedures (or a set of instructions) for handling various basic system services for performing hardware-dependent tasks. While not shown in FIG. 4, the operating system 426 may include a web browser (or set of instructions) for providing and/or rendering information in web pages. Memory 424 may also store communications procedures (or a set of instructions) in a communication module 428. These communication procedures may be used for communicating with: one or more computers, devices and/or servers, including computers, devices and/or servers that are remotely located with respect to the computer system 400.

Memory 424 may also include one or more program modules (or a set of instructions), including: discovery module 430 (or a set of instructions), investigation module 432 (or a set of instructions), and remedial-action module 434 (or a set of instructions).

After receiving one or more requests 436, such as a request from potential user A 438-1 or potential user B 438-2 regarding their online accounts, discovery module 430 may access stored information, such as account information 440 and/or registered-user information 444. For example, for an e-mail account, account information 440 may include history information 442, such as frequent e-mail contacts, recent e-mails sent or received, and/or one or more locations from which the registered-user accessed the e-mail account. Moreover, registered-user information 444 may include past (inactive) and current login information 446, which may include one or more locations from which this information was received, as well as any other services 448 that the registered users receive from the service provider(s) associated with their online accounts. For example, a service provider may support a user's e-mail account and may host the user's blog.

Then, investigation module 432 may determine if a potential user associated with a given request is the owner of a given online account, even if the potential user does not match the current registered user per registered-user information 444. For example, investigation module 432 may compare a weighted summation of factors to one or more thresholds 450, where different factors may be associated with different weights 452. These factors may include comparisons of stored information and information provided by potential users along with requests 436.

Based at least in part on the calculation performed by investigation module 432, remedial-action module 434 may perform remedial action in response to the requests 436. For example, if the weighted sum exceeds a high threshold, the given online account may be restored to the potential user by providing existing or new login information 446. However, if the weighted sum is less than a low threshold, the given online account may be deactivated. And if the weighted sum is between these thresholds, no action may be taken in response to the given request. Regardless of the decision, communication module 428 may communicate the remedial action taken to the potential user.

Instructions in the various modules in the memory 424 may be implemented in: a high-level procedural language, an object-oriented programming language, and/or in an assembly or machine language. The programming language may be compiled or interpreted, i.e., configurable or configured, to be executed by the one or more processing units 410.

Although the computer system 400 is illustrated as having a number of discrete components, FIG. 4 is intended to be a functional description of the various features that may be present in the computer system 400 rather than a structural schematic of the embodiments described herein. In practice, and as recognized by those of ordinary skill in the art, the functions of the computer system 400 may be distributed over a large number of servers or computers, with various groups of the servers or computers performing particular subsets of the functions.

In some embodiments, some or all of the functionality of the computer system 400 may be implemented in one or more application-specific integrated circuits (ASICs) and/or one or more digital signal processors (DSPs). Moreover, the functionality of computer system 400 may be implemented more in hardware and less in software, or less in hardware and more in software, as is known in the art.

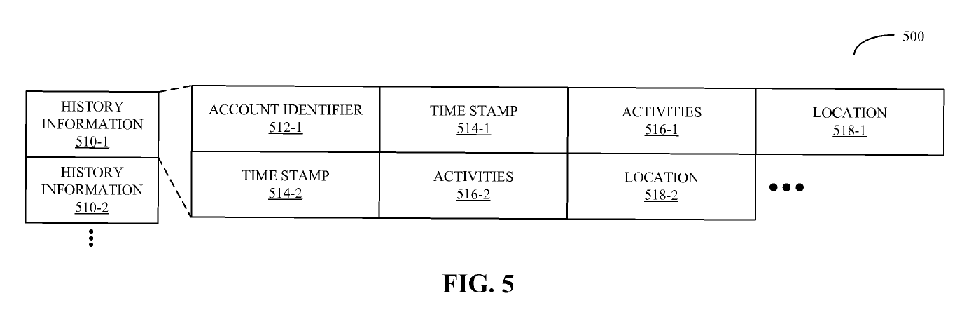

We now describe embodiments of a data structure that may be used in computer system 200 (FIG. 2) and 400. FIG. 5 presents a block diagram illustrating an embodiment of a data structure 500. This data structure may include history information 510. For example, history information 510-1 may include account identifier 512-1 and multiple instances of time stamps 514 when an online account was accessed or activities were performed, account activities 516 (such as individuals that were e-mailed), and locations 518 from which a user accessed the online account or performed activities 516.

Computer system 200 (FIG. 2), web page 300 (FIG. 3), computer system 400 (FIG. 4), and/or data structure 500 may include additional or fewer components. Moreover, two or more components may be combined into a single component, and/or a position of one or more components may be changed.

The foregoing descriptions of embodiments have been presented for purposes of illustration and description only. They are not intended to be exhaustive or to limit the present embodiments to the forms disclosed. Accordingly, many modifications and variations will be apparent to practitioners skilled in the art. Additionally, the above disclosure is not intended to limit the present embodiments. The scope of the present embodiments is defined by the appended claims.

What is claimed is:

1. A method for responding to a request for corrective action, comprising:
receiving the request for corrective action from a potential user of an online account, wherein the request includes account information, registered-user information and history information for activities associated with the online account;
accessing stored information for the online account, wherein the stored information includes stored history information for activities associated with the online account;
generating an ownership score based at least in part on the information in the request and the stored information for the online account;
determining if the potential user is an owner of the online account based at least in part on the ownership score; and
performing remedial action in response to the request.

2. The method of claim 1, wherein the remedial action includes returning control of the online account to the owner.

3. The method of claim 1, wherein the remedial action includes disabling the online account.

4. The method of claim 1, wherein the remedial action includes providing login information to the owner.

5. The method of claim 1, wherein the remedial action includes taking no action in response to the request.

6. The method of claim 1, further comprising communicating to the potential user the remedial action performed in response to the request.

7. The method of claim 1, wherein the request is included in a document that is submitted online.

8. The method of claim 7, wherein the document includes a web page.

9. The method of claim 1, wherein, during normal operation, the online account is accessed by providing login information.

10. The method of claim 1, wherein the online account is associated with an e-mail account, a blog, a website, a search history, health records, an advertising account, or a merchandise account.

11. The method of claim 1, wherein the potential user submits the request if the potential user has lost control over the online account.

12. The method of claim 11, wherein loss of control includes forgetting login information associated with the online account.

13. The method of claim 11, wherein loss of control includes an unauthorized party taking control of the online account.

14. The method of claim 1, wherein the registered-user information includes information associated with other services provided to the potential user by a host of the online account.

15. The method of claim 1, wherein the account information includes currently inactive login information that was previously used to access the online account.

16. The method of claim 1, wherein the history information for activities associated with the online account includes account activities within a time interval.

17. The method of claim 16, wherein the account activities within the time interval include individuals e-mailed by the potential user.

18. The method of claim 1, wherein the determining if the potential user is the owner involves comparing a weighted summation of determining factors to a threshold value.

19. The method of claim 1, wherein the stored history information for activities associated with the online account includes one or more locations of a registered user when the registered user previously accessed the online account.

20. The method of claim 19, wherein the determining if the potential user is the owner involves comparing a location of the potential user at a time the requested was submitted with the one or more locations.

21. The method of claim 19, wherein the determining if the potential user is the owner involves comparing a location from which a most-recent change to the account was received with the one or more locations.

22. A computer-program product for use in conjunction with a computer system, the computer-program product comprising a computer-readable storage medium and a computer-program mechanism embedded therein for configuring the computer system, the computer-program mechanism including:
instructions for receiving a request for corrective action from a potential user of an online account, wherein the request includes account information, registered-user information and history information for activities associated with the online account;
instructions for accessing stored information for the online account, wherein the stored information includes stored history information for activities associated with the online account;
instructions for generating an ownership score based at least in part on the information in the request and the stored information for the online account;
instructions for determining if the potential user is an owner of the online account based at least in part on the ownership score; and
instructions for performing remedial action in response to the request.

23. A computer system, comprising:
a processor;
memory;
a program module, wherein the program module is stored in the memory and configured to be executed by the processor, the program module including:
instructions for receiving a request for corrective action from a potential user of an online account, wherein the request includes account information, registered-user information and history information for activities associated with the online account;
instructions for accessing stored information for the online account, wherein the stored information includes stored history information for activities associated with the online account;
instructions for generating an ownership score based at least in part on the information in the request and the stored information for the online account;
instructions for determining if the potential user is an owner of the online account based at least in part on the ownership score; and
instructions for performing remedial action in response to the request.
